(19) United States
(12) Patent Application Publication
(10) Pub. No.: US 2012/0070637 A1
(43) Pub. Date: Mar. 22, 2012

(54) GRAPHIC MAT AND METHOD OF MANUFACTURE

(76) Inventor: MARK GROSS, Ft. Lauderdale, FL (US)

(21) Appl. No.: 13/219,187

(22) Filed: Aug. 26, 2011

Related U.S. Application Data
(63) Continuation-in-part of application No. 12/031,507, filed on Feb. 14, 2008.
(60) Provisional application No. 60/890,493, filed on Feb. 18, 2007.

(51) Int. Cl. B32B 3/00

(52) U.S. Cl. 428/201

(57) ABSTRACT

The present invention relates to multi-layer mats that display a graphic image printed on an intermediate layer of the mat. Mats of the present invention have a base layer, and an intermediate layer with graphics thereon.

### RELATED APPLICATIONS

This application is a continuation-in-part of U.S. application Ser. No. 12/031,507, filed on Feb. 14, 2008, currently pending, which claims the benefit of U.S. Provisional Patent Application Ser. No. 60/890,493, filed on Feb. 18, 2007, currently pending, the disclosures of which are hereby incorporated by reference in their entirety.

### BACKGROUND

The present invention generally relates to image bearing mats. More particularly, the present invention relates to multi-layer mats that display a graphic image printed on an intermediate layer of the mat.

The advertising of goods and services can include displays of information including text and graphics to assist the consumer in making purchasing decisions. There is a wide range of modes of advertising, including television, radio, print including newspapers and magazines, brochures, and point-of-purchase literature and displays. Point-of-purchase literature and displays include brochures, cards, fliers, signs and the like, located at or in proximity to the goods or services being provided.

Mats that include text and graphics related to a product are one type of display advertising. Typically, such mats are placed on the floor or on a countertop surface in proximity to the location of the related product. One type of mat is textile based, where the mat is provided with graphics by colorizing the textile pile and arranging in a way to create meaningful content. A second type of mat for indoor use is a printed vinyl sheet with an adhesive backing thereon. The adhesive is typically covered with a releasable protective sheet until the mat is to be used, and then secures the mat to a surface after the releasable protective sheet is discarded. A third type of mat includes a vinyl sheet on which text or graphics are printed. The vinyl sheet is typically bonded to a rubber base using a vulcanization or heat process. Because the vinyl sheet and the uncured rubber are heat vulcanized, the stratas meld together as one.

While known mats can be used to provide point-of-purchase display information for use in stores, there are drawbacks to these devices. For example, with respect to the vinyl sheet bonded to rubber, the vulcanization process tends to degrade the graphic quality. Further, manufacturing such mats requires the vulcanization of the laminate to meld the layers to form a unitary rubber mat. Vulcanization equipment is specialized, and impractical for other than large manufacturing facilities. This equipment is typically too costly for even large print shops that conventionally make signs using large format printers and laminators. In addition, operational constraints are costly for heat vulcanization due to air quality requirements arising from control and filtering of fumes released in the vulcanization process.

### BRIEF SUMMARY

The present invention relates to multi-layer mats that display a graphic image printed on an intermediate layer of the mat.

In one aspect, a multi-layer graphic mat is provided that includes a base layer a base layer having a first base surface and a second base surface, an intermediate layer having a first intermediate surface and a second intermediate surface, the second intermediate surface of the intermediate layer being attached to the first base surface of the base layer, and graphics applied to the intermediate layer. In some examples, the graphics are applied to the second intermediate surface of the intermediate layer.

### BRIEF DESCRIPTION OF SEVERAL VIEWS OF THE DRAWINGS

FIG. 1 is a top perspective partially cut-away view of one example of a multi-layer graphic mat according to the present invention.

FIG. 2 illustrates a bottom perspective exploded view of the multi-layer graphic mat of FIG. 1.

FIG. 3 is a schematic illustration of a process for manufacturing the multi-layer laminated graphics mat illustrated in FIG. 1.

### DETAILED DESCRIPTION

Preferred embodiments of multi-layer graphic mats and processes for making such mats are illustrated in FIGS. 1-3, in which like components have like reference numerals.

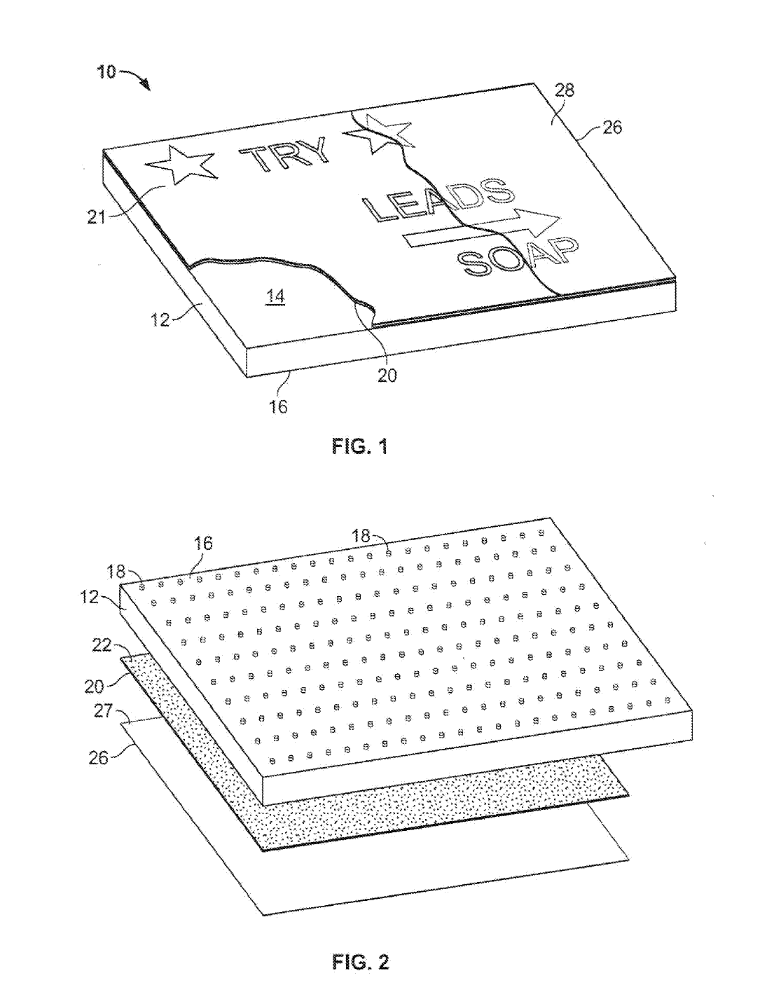

FIG. 1 illustrates a cut-away view of one example of a multi-layer graphic mat 10 in accordance with the present invention. The mat 10 has a base layer 12, which has first base surface 14 and a second base surface 16. Base layer 12 is preferably made of rubber, such as, for example, nitrile rubber. Such rubber is commercially available, and is generally provided in large rolls that can be handled on roller carts of a type commonly found in print shops for rolls of vinyl and other materials used for signage. Base layer 12 can have any suitable thickness, but preferably has a thickness of from about 30 mil (0.030 inches) to about 150 mil (0.150 inches). First base surface 14 is preferably smooth, with little or no texture. Second base surface 16 is opposite first base surface 14, and usually acts as the contact surface between the multi-layer graphic mat 10 and the surface upon which it is to be displayed. Second base surface 16 can be smooth, or can have texture. In the embodiment illustrated in FIG. 2, second base surface 16 includes a plurality of projecting stubs 18. A texture, such as projecting stubs 18, can enhance the contact between the mat 10 and the surface upon which it is to be displayed, and facilitate the maintenance of the mat 10 in its placement position. For example, a surface such as projecting stubs 18 or cleats is particularly preferred when the graphic mat is to be placed upon a carpeted surface. for carpet surface applications. When the graphic mat is to be placed on a hard floor surface, it is preferred that second base surface 16 be smooth.

Referring to FIGS. 1 and 2, the mat 10 includes an intermediate graphic layer 20 attached to the base layer 12. As illustrated in FIGS. 1 and 2, the intermediate graphic layer 20 has a first intermediate surface 21 and a second intermediate surface 22. As illustrated in FIGS. 1 and 2, the intermediate graphic layer 20 is equal in size to the base layer 12. In other embodiments, the base layer 12 can be larger than the intermediate graphic layer 20. In such embodiments, the first base surface 14 preferably has a window area and a border area, and the intermediate graphic layer 20 is attached to the window area of the first base surface 14. In some embodiments, the base layer 12 can be a pre-molded mat base having a border area and a surface recess that defines the window area. Preferably, when graphic layer 20 is adhered to the window area of base layer 12, the height of first intermediate surface 21 is approximately even with the height of the border area of first base surface 14. Such a configuration, having a a recessed window area, can serve to protect the edges of the graphic layer 20 in high traffic applications. The window area can be an integral part of the base layer 12, or can be a removable component. In such embodiments, the border area of the first base surface 14 can have a texture, such as, for example, a treaded texture, to increase the coefficient of friction between the border area of the first base surface 14 and the feet of people that might walk upon the mat 10.

The intermediate graphic layer can have any suitable thickness, but preferably has a thickness of from about 10 mil (0.010 inches) to about 75 mil (0.075 inches), including being from about 50 mil (0.050 inches) to about 75 mil (0.075 inches). The intermediate graphic layer is preferably made of a printable sheet material. The printable sheet material of intermediate graphic layer 20 is preferably a rigid, yet flexible, material suitable for printing, and can include, for example, polystyrene and polyvinyl chloride (PVC). A rigid, yet flexible, sheet material facilitates manual assembly of the intermediate graphic layer 20 to the base layer 12 without trapping air bubbles between the layers. Flexible printed vinyl, however, is inappropriate as the flaccidity of vinyl allows the sheet to separate from the rubber backing when the finished product is rolled for shipping and storage.

The first intermediate surface 21 of intermediate layer 20 has graphics thereon. Graphics can include, for example, text, images, shapes, patterns, solid colors, or combinations thereof. Graphics can be applied to the intermediate layer in any suitable manner, such as being printed by UV digital or screen printing methods. As illustrated in FIG. 1, there are graphics on substantially the entire width and height of the first intermediate surface, which can be referred to as being “full bleed” graphics. In some embodiments, the first intermediate surface has a graphics area having a first set of graphics thereon and a border area.

In an alternative example, the graphics can be printed on the second intermediate surface 22 of intermediate layer 20. In such an example, the intermediate layer can be an optically clear material, such as PVC, and the graphics can be applied to the second intermediate surface 22 of intermediate layer 20, such as by being reverse printed so that they are correctly oriented for being viewed through the intermediate layer. In such an example, the graphics can be protected by the thickness of the intermediate layer above the graphics, and by the base layer underneath the graphics.

It should be understood that “optically clear” as used herein means that a person can see through the layer with sufficient clarity to view and discern the graphics. A material that is optically clear may include a color, texture, or a level of distortion, as long as those properties do not unreasonably interfere with a person's ability to view and discern the graphics. For example, when the graphics are printed on the second intermediate surface 22 of intermediate layer 20, the first intermediate layer 21 may include a surface texture, or other satisfactory non-slip performance, such that people can safely walk on the mat 10. One standard by which the non-slip performance can be measured is ASTM D 2047, which measures the static coefficient of friction of polish-coated flooring surfaces with respect to human locomotion safety. The contents of ASTM D 2047 are hereby incorporated by reference in their entirety.

As shown in FIG. 2, second intermediate surface 22 of intermediate graphic layer 20 has an adhesive layer attached thereto or formed thereon, which can be used to attach intermediate graphic layer 20 to base layer 12. In some examples, a transfer adhesive can be used, and prior to the attachment of intermediate graphic layer 20 to base layer 12, the adhesive layer can be covered by a detachable release liner. Removing the release liner exposes the adhesive coated second intermediate surface 22 of intermediate graphic layer 20 for affixing to the first base surface 14 of base layer 12. In examples where the graphics are printed on the second intermediate surface 22 of intermediate layer 20, the adhesive can be applied to the graphics. In one such example, a transfer adhesive can be laminated over the graphics on the second intermediate surface 22 of intermediate layer 20, the release liner can be removed from the transfer adhesive, and the intermediate layer can be attached to the base layer by the adhesive layer. Preferably, a laminator can be used to remove the release liner and attach the intermediate graphic layer 20 to the base layer 12. Such lamination is preferably accomplished by compression. The adhesive layer preferably allows the intermediate graphic layer 20 to adhere to the base layer 12 such that the mat 10 can be rolled into a compact shape for shipping and storage.

As illustrated in FIGS. 1 and 2, the multi-layer graphic mat 10 may also include an optional top layer 26 having a first top surface 28 and a second top surface 27. Top layer 26 is preferably made of an optically clear material. The top layer 26 protects the first intermediate surface 21 of the intermediate graphic layer 20, and the graphics thereon. Preferably, top layer 26 also provides a surface having satisfactory non-slip performance, such that people can safely walk on the mat 10. One standard by which the non-slip performance can be measured is ASTM D 2047, discussed above. The contents of ASTM D 2047 are hereby incorporated by reference in their entirety. One example of a particularly preferred material from which top layer 26 can be made is FLEX MARK OV 600, available from Flexcon Company, Inc. of Spencer, Mass., which is a flexible clear embossed top sheet available in rolls of differing widths.

As shown in FIG. 2, second top surface 27 of top layer 26 has an adhesive layer attached thereto or formed thereon, which can be used to attach top layer 26 to intermediate graphic layer 20. Prior to the attachment of top layer 26 to intermediate graphic layer 20, the adhesive layer can be covered by a detachable release liner. Removing the release liner exposes the adhesive coated second top surface 27 of top layer 26 for affixing to the first intermediate surface 21 of intermediate layer 20. Preferably, a laminator is used to remove the release liner and attach the top layer 26 to intermediate graphic layer 20. Such lamination is preferably accomplished by compression.

In the embodiment illustrated in FIGS. 1 and 2, the top layer 26 is equal in size to both the intermediate graphic layer 20 and the base layer 12. In embodiments where the base layer 12 is larger than the intermediate layer 20, however, such as described above, the top layer 26 is preferably equal in size to the intermediate graphic layer 20. In some such embodiments, the top layer 26 and the intermediate graphic layer 20 can be attached to each other separately from the base layer 12. In such embodiments, the intermediate graphic layer 20 preferably has a first intermediate surface 21 with graphics thereon and a second intermediate surface 22 having an adhesive layer attached thereto. The top layer 26 is preferably attached to the first intermediate surface 21 of the intermediate layer 20. The adhesive layer attached to the second intermediate surface 22 will stick to either the first top surface of a second top layer or to a rubber base layer. In this manner, graphics originally provided with, or as part of, a mat, can be replaced.

In particularly preferred embodiments, the multi-layer mat 10 can be rolled into a compact shape for shipping and storage in a tube. The mat 10 can then be readily removed from the tube and unrolled to lie on a floor or other surface in proximity to goods or services to be sold. The base layer 12 provides a frictional holding surface against the floor or other surface without chemical adhesive bonding or attaching, while the top layer 26 provides a walkable and skuff resistant surface through which the printed graphics 21 are readily visible.

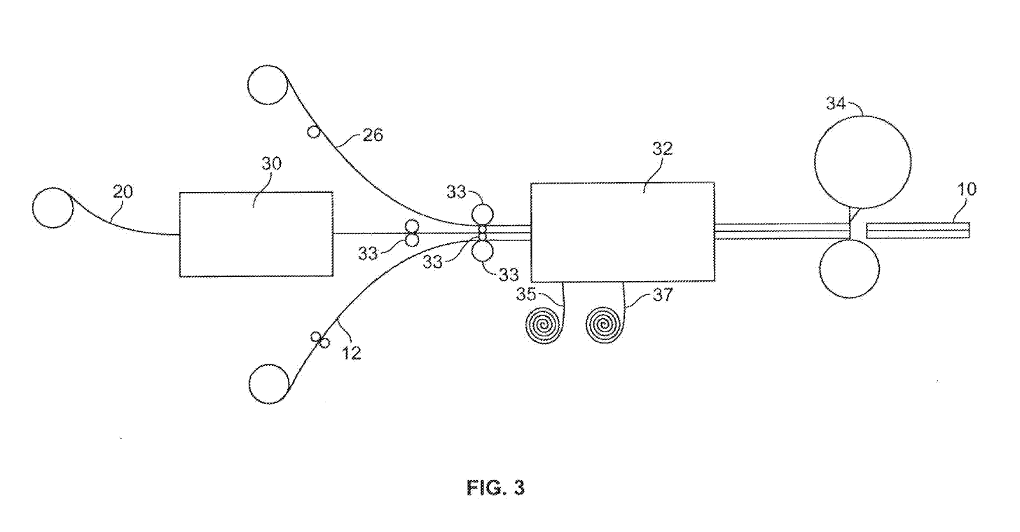

FIG. 3 illustrates a schematic view of a preferred process for manufacturing multi-layer graphic mats of the present invention, such as the mat 10 illustrated in FIGS. 1 and 2.

As illustrated, the process includes providing a base layer material 12, an intermediate graphic layer material 20, and a top layer material 26. The base layer material 12 preferably has a first base surface and a second base surface. The intermediate graphic layer material 20 preferably has a first intermediate surface and a second intermediate surface. The top layer material preferably has a first top surface and a second top surface. Each of the materials can be provided as sheet material in rolls of any suitable length.

The process also includes printing graphics onto the first intermediate surface of the intermediate graphic layer 20. The intermediate graphic layer 20 can be printed with graphics using a large format printer 30 that receives the intermediate graphic layer material 20 for continuous printing. In one example, a 150 foot roll of intermediate graphic layer material 20 having a forty-eight inch width can be printed with fifteen units of a 4 foot by 10 foot graphic display. In various embodiments, the printing can be accomplished by digital printing, such as with ultra-violet ink or solvent based ink, screen printing, or by any other suitable type of printing.

The process further includes laminating the base layer, the intermediate graphic layer, and the top layer to form a multi-layer graphic mat. As illustrated in FIG. 3, the printed intermediate graphic layer material 20 is assembled with the top layer 26 and the base layer 12 to form the mat 10. The leading edge of the intermediate graphic layer 20 is aligned with the leading edge of top layer 26 and with rubber layer 12. The materials are fed into a laminator 32. Preferably, the laminator has rollers 33 that can be used for guiding and controlling the path of the layers. For embodiments where the second intermediate surface of intermediate graphic layer 20 and the second top surface of top layer 26 each have an adhesive layer attached thereto, the laminator 32 preferably peels back the release layer 35 of the intermediate graphic layer 20 and the release layer sheet 37 of the top layer 26. The laminator 32 then presses the material layers together such that the first base surface becomes adhesively attached to the second intermediate surface, and the first intermediate surface becomes adhesively attached to the second top surface. The mats 10 can separated by being cut with blade, such as a knife or a knife roller 34.

From the foregoing, it will be appreciated that although specific embodiments of the invention have been described herein for purposes of illustration, various modifications may be made without deviating from the spirit or scope of the invention. It is therefore intended that the foregoing detailed description be regarded as illustrative rather than limiting, and that it be understood that it is the following claims, including all equivalents, that are intended to particularly point out and distinctly claim the subject matter regarded as the invention.

What is claimed is:

1. A multi-layer graphic mat comprising:
a base layer having a first base surface and a second base surface;
an intermediate layer having a first intermediate surface and a second intermediate surface, the second intermediate surface of the intermediate layer being attached to the first base surface of the base layer; and
graphics applied to the intermediate layer.

2. The multi-layer graphic mat of claim 1, wherein the base layer comprises rubber.

3. The multi-layer graphic mat of claim 2, wherein the base layer comprises nitrile rubber.

4. The multi-layer graphic mat of claim 1, wherein the intermediate layer is optically clear.

5. The multi-layer graphic mat of claim 4, wherein the intermediate layer comprises PVC.

6. The multi-layer graphic mat of claim 1, wherein the graphics are applied to the second intermediate surface of the intermediate layer.

7. The multi-layer graphic mat of claim 1, wherein the intermediate layer has a thickness of from about 10 mil (0.010 inches) to about 75 mil (0.075 inches).

8. The multi-layer graphic mat of claim 7, wherein the intermediate layer has a thickness of from about 50 mil (0.050 inches) to about 75 mil (0.075 inches).

9. The multi-layer graphic mat of claim 1, wherein the second intermediate surface of the intermediate layer is attached to the first base surface of the base layer by an adhesive layer.

10. The multi-layer graphic mat of claim 9, wherein the adhesive layer is a transfer adhesive.
